(19) United States
(12) Patent Application Publication
(10) Pub. No.: US 2004/0189697 A1
(43) Pub. Date: Sep. 30, 2004

(54) Dialog control system and method

(75) Inventors: Toshiyuki Fukuoka, Kawasaki (JP); Eiji Kitagawa, Kawasaki (JP); Ryosuke Miyata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/766,928

(22) Filed: Jan. 30, 2004

(30) Foreign Application Priority Data
Mar. 24, 2003 (JP) 2003-081136

(51) Int. Cl. G09G 5/00

(52) U.S. Cl. 345/748; 345/751; 709/217

(57) ABSTRACT

There are provided a dialog control system and a dialog control method for realizing a smooth dialog dynamically corresponding to contents of a natural dialog by a user without allowing the user to be aware of an operation history. The dialog control system interprets the input information input by the user, identifies a plurality of dialog agents for responding to the input information, transmits the input information to the dialog agent to request a response to the input information, and outputs a response from the dialog agent. Processable information is inquired about with respect to a plurality of dialog agents. The input information is matched with the processable information. A dialog agent capable of processing the input information is selected. The input information is transmitted to the selected dialog agent, and a dialog control part receives a response thereto.

### BACKGROUND OF THE INVENTION

1. Field of the Invention

The present invention relates to a dialog control system and method for allowing information to be smoothly exchanged between a computer and a user.

2. Description of the Related Art

Due to the recent rapid enhancement of the processing ability of a computer, and the widespread use of a communication environment such as the Internet, a user has more chances to obtain information and send information through a computer. Such an information service using a computer is provided in a wide range of fields. In addition to users familiar with computers, for example, users unfamiliar with or inexperienced in computers also have more chances to use such an information service. Furthermore, it is expected that a broadband system will advance rapidly in the Internet environment in the future, and an information service for providing a greater amount of information is considered to increase.

Under such a circumstance, in a dialog service predicated on the dialog with a system, it is becoming difficult to request an input in accordance with a recognition grammar previously assumed to be used by users. More specifically, contents that have not been considered at a time of assuming a recognition grammar may be input. Alternatively, a dialog does not converge in one dialog agent, and is likely to be performed among a plurality of dialog agents. Even in such a case, there is an increasing demand for establishment of a dialog.

Thus, a user interface technique is being developed in various aspects, which allows the above-mentioned information service to be enjoyed by a user while the user is performing a natural dialog with a system.

For example, a technique of configuring an information service application utilizing a speech interface, using middleware such as VoiceXML and SALT is being developed. FIG. 1 is a diagram showing a configuration of a dialog system in the case of using middleware.

As shown in FIG. 1, user input information input from an input part 101, computer processing with respect to the user input information, and processing of a screen and a speech output to the output part 102 are described in a dialog application 104, whereby the processing of generating output information corresponding to input information can be performed by middleware 103, and the dialog system can be operated smoothly. With this configuration, computers can replace a window-service in a bank, a telephone reception in a company, and the like.

The following is also considered. In order for a user to know a method for smoothly performing a dialog using the dialog system, the contents of the dialog performed by other users are set so as to be known, whereby the user can learn what input allows the user to obtain desired information.

For example, JP 11(1999)-15666 A discloses a technique in which a user performs a dialog with a system using an arbitrary dialog agent, and the contents of the dialog performed via the dialog agent are released to other users (third party).

On the other hand, it is also considered that user input contents are analyzed so that a dialog agent corresponding to the input contents can be selected, whereby any contents input by a user can be handled.

For example, JP 2001-337827 A discloses a technique of mediating in a dialog with a dialog agent suitable for user input contents, using a help agent that mediates between the user and the dialog agent.

### SUMMARY OF THE INVENTION

It is an object of the present invention to provide a dialog control system and method for realizing a smooth dialog dynamically corresponding to the contents of a natural dialog by a user without allowing the user to be aware of an operation history.

In order to achieve the above-mentioned object, a dialog control system according to the present invention includes: an input part for interpreting input information input by a user; a dialog agent for responding to the input information; and a dialog control part placed between the dialog agent and the input part, for identifying a plurality of the dialog agents, transmitting the input information to the dialog agent to request a response to the input information, and transmitting a response from the dialog agent to an output part. When the input information is input, the dialog control part inquires about processable information with respect to the plurality of dialog agents, stores the processable information, matches the input information with the processable information, selects the dialog agent capable of processing the input information, and transmits the input information to the selected dialog agent to receive a response thereto.

According to the above-mentioned configuration, a dialog agent capable of processing input information can be selected exactly, and dialog agents can be changed every time input information is input. Therefore, a smooth dialog can be performed in a state close to a natural dialog in which the category of input information is changed frequently.

Furthermore, in the dialog control system according to the present invention, it is preferable that the dialog control part previously stores identification information of the dialog agents and selection priority of the dialog agents so that the identification information is associated with the selection priority, refers to the dialog agents in a decreasing order of the selection priority when referring to the input information and the processable information, and transmits the input information to the first selected dialog agent to request a response to the input information.

Furthermore, in the dialog control system according to the present invention, it is preferable that the dialog control part accumulates identification information of the dialog agent selected as a transmission destination of the input information, refers to the first stored dialog agent when selecting the subsequent dialog agent, in a case where the stored dialog agent is capable of processing the input information, transmits the input information to the stored dialog agent to request a response to the input information, and in a case where the stored dialog agent is not capable of processing the input information, refers to the dialog agents in a decreasing order of the selection priority. According to the above configuration, a dialog agent that has performed a dialog with respect to the previous input is most probably used continuously.

Furthermore, in the dialog control system according to the present invention, it is preferable that the selection priority of the dialog agent is automatically updated in accordance with a use frequency.

Furthermore, in the dialog control system according to the present invention, it is preferable that, in the dialog control part, the control agents to be referred to are narrowed in accordance with contents of the input information, and the narrowed dialog agents are referred to in a decreasing order of the selection priority. Furthermore, in the dialog control system according to the present invention,-it is preferable that the dialog control part stores the identification information of the dialog agent determined to be available based on the processable information on a basis of the dialog agents, and the dialog control part inquires about the processable information with respect to only the dialog agent determined to be available. According to the above configuration, waste of computer resources can be prevented by avoiding useless reference processing.

Furthermore, in the dialog control system according to the present invention, it is preferable that the dialog control part includes a user information input part for inputting information for identifying a user, stores input information for identifying the user and information on a state using the dialog agent including the selection priority on a user basis, and performs processing in accordance with the selection priority on a user basis. According to the above configuration, by storing a dialog situation on a user basis, a user can easily return to an original dialog situation even if a dialog is not performed continuously.

Furthermore, the present invention is characterized by software for executing the functions of the above-mentioned dialog control system as processing operations of a computer. More specifically, the present invention is directed to a dialog control method including inquiring about processable information with respect to a plurality of dialog agents making responses corresponding to input information, and storing obtained processable information; interpreting input information input by a user; matching the input information with the processable information, selecting the dialog agent capable of processing the input information, and transmitting the input information to the selected dialog agent to request a response to the input information; and receiving the response from the dialog agent and outputting it, and to a program product storing a program allowing a computer to execute these operations on a recording medium.

According to the above configuration, by loading the program onto a computer, a dialog agent capable of processing input information can be selected exactly, and dialog agents can be changed every time the input information is input. Therefore, a dialog control system can be realized, which is capable of performing a smooth dialog in a state close to a natural dialog in which the category of input information is changed frequently.

These and other advantages of the present invention will become apparent to those skilled in the art upon reading and understanding the following detailed description with reference to the accompanying figures.

### BRIEF DESCRIPTION OF THE DRAWINGS

FIG. 1 is a diagram showing a configuration of a conventional dialog system.

FIG. 2 is a diagram illustrating a menu configuration in the conventional dialog system.

FIG. 3 is a diagram showing a configuration of a dialog control system according to an embodiment of the present invention.

FIG. 4 is a diagram showing a configuration of a dialog control part in the dialog control system according to the embodiment of the present invention.

FIG. 5 is a flow chart showing processing of the dialog control part in the dialog control system according to the embodiment of the present invention.

FIG. 6 is a diagram showing a configuration of an agent managing part in the dialog control system according to the embodiment of the present invention.

FIG. 7 is a flow chart showing input information processing of an agent managing part in the dialog control system according to the embodiment of the present invention.

FIG. 8 is a flow chart showing response request processing of the agent managing part in the dialog control system according to the embodiment of the present invention.

FIG. 9 is a flow chart showing processable information registration request processing of the agent managing part in the dialog control system according to the embodiment of the present invention.

FIG. 10 is a diagram showing another configuration of the dialog control system according to the embodiment of the present invention.

FIG. 11 is a diagram showing still another configuration of the dialog control system according to the embodiment of the present invention.

FIG. 12 is a diagram showing a dialog control system according to an example of the present invention.

FIG. 13 is a diagram illustrating input information in the dialog control system according to the example of the present invention.

FIG. 14 is a diagram illustrating a state transition of a weather agent in the dialog control system according to the example of the present invention.

FIG. 15 is a diagram illustrating a state transition of a car navigation agent in the dialog control system according to the example of the present invention.

FIG. 16 is a diagram illustrating dialog results in the dialog control system according to the example of the present invention.

FIG. 17 is a diagram illustrating a computer environment.

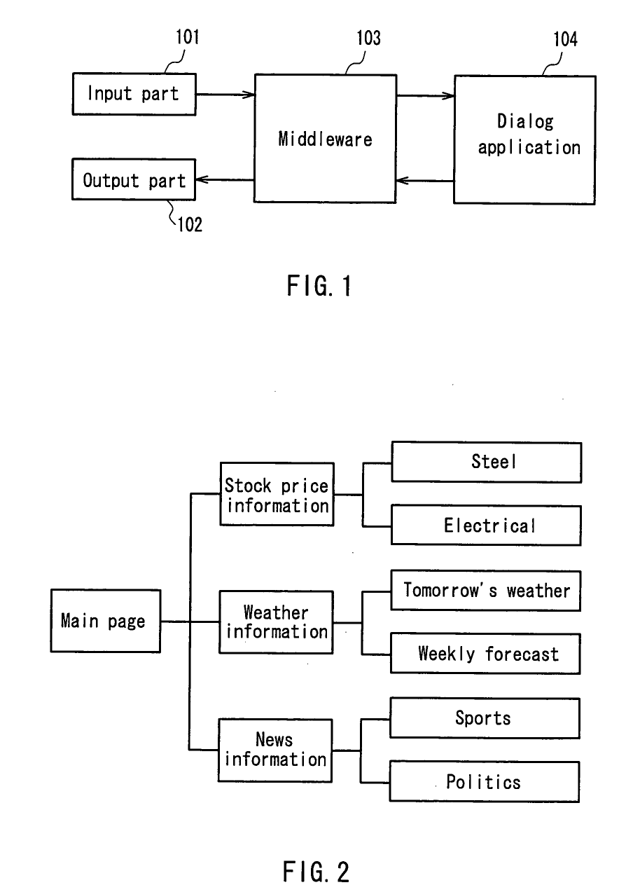

### DESCRIPTION OF THE PREFERRED EMBODIMENTS

However, although the above-mentioned user interface is effective in a single operation for use in withdrawing at a bank window, etc., it is difficult for a system to perform a natural dialog with a user in the case of performing various procedures and operations, because the user interface is standardized.

For example, in the case of using a GUI of Windows (R) or the like produced by Microsoft Corp., in order to perform operations simultaneously with respect to a plurality of applications, it is required to explicitly switch applications using a mouse, a keyboard, or the like. Furthermore, regarding services and the like provided by a speech portal, it is required for a user to explicitly switch different functions and services by using a speech. Particularly, in the case of repeatedly switching a plurality of services and functions over a long period of time, it is required for a user to memorize how the user has used the services and the functions in the past, which becomes a burden on the user.

Furthermore, in the case where there are a plurality of services and functions, supply paths of services and the like are often provided using a menu tree as shown in FIG. 2. There is no particular problem in the case where the menu tree is followed from a main page that is a root tree of the menu tree, every time a user uses the services and functions. However, in the case where, while a user enters from a root tree to an inner tree to use a service or the like, the user is required to move to another tree, an operation of returning to the root tree of the menu tree, an operation of returning from another tree of a movement destination to the original menu tree, and the like are required. Thus, an operation load on a user is increased.

For example, in FIG. 2, when a user selects “Sports” from “News information” and is reading an article in “Sports”, the user is anxious about “Weekly forecast” of “Weather information”, the user needs to return to the main page and shift the menu in the order of “Weather information” and “Weekly forecast”. Then, in the case where the user returns to “Sports”, the user needs to repeat the same operation.

In order to solve such a problem, it is considered that a path capable of directly moving from each menu to another menu is added. However, as the number of menus is increased, or a menu hierarchy is increased, the number of such paths is also increased in an exponential series manner, and the vocabulary to be recognized in a GUI display and a speech input corresponding to the menus or the menu hierarchy is also increased. Thus, adding such a path cannot be a realistic solution.

Furthermore, according to the method described in JP 2001-337827 A, the contents of a dialog in each dialog agent by a user are recorded, and regarding a dialog agent that has not finished a dialog, an input guidance in the dialog agent that has not finished a dialog can be performed as a system response, even when another dialog agent is being used. However, in the case where a considerable number of dialog agents are used simultaneously, a plurality of system responses are repeatedly output. Furthermore, particularly in the case where a response is made using a speech, since it is more difficult for a user to recall the previous contents with the passage of time, the user interface becomes a far cry from natural dialog feelings and impractical for a user.

Furthermore, in order to respond to an arbitrary dialog input, it is required for all the dialog agents to prepare a recognition grammar that can handle any input speeches. However, there is a physical constraint of the capacity and the like of a storage apparatus such as a disk. Therefore, it is actually difficult for all the dialog agents to prepare such a recognition grammar.

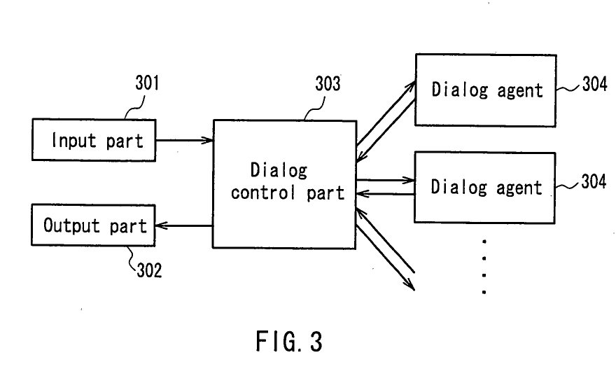

Hereinafter, a dialog control system according to an embodiment of the present invention will be described with reference to the drawings. FIG. 3 is a diagram showing a configuration of the dialog control system according to the embodiment of the present invention. In FIG. 3, a user utterance, text data, or the like is input as input information by a user from an input part 301. It is assumed that, for example, in the case where speech data such as a user utterance is input, the input part 301 performs speech recognition and converts the speech data into digital data such as text data so that the speech data can be used by a dialog control part 303.

The information input to the input part 301 is given to the dialog control part 303. The dialog control part 303 manages a plurality of previously registered dialog agents 304. The dialog control part 303 selects a dialog agent capable of processing the input information among them, and requests the dialog agent 304 thus selected to perform response processing. Then, the dialog control part 303 notifies an output part 302 of the response processing results in the selected dialog agent 304, and performs output processing to the user.

It is also considered that middleware for organizing an input/output and performing event processing such as a timer is placed between the input part 301 and the output part 302, and the dialog control part 303. As a result, existing dialog middleware such as VoiceXML and SALT can be effectively used.

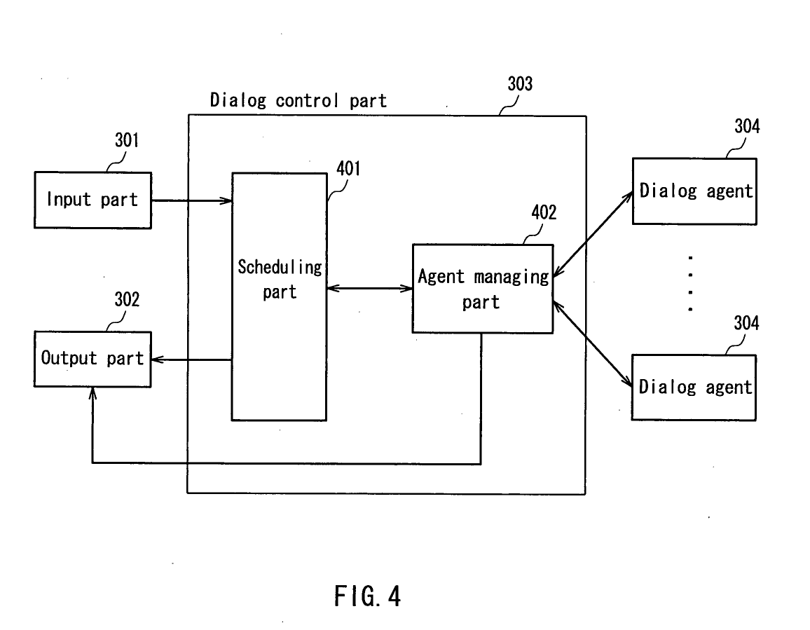

FIG. 4 is a diagram showing a configuration of the dialog control part 303 in the dialog control system according to the embodiment of the present invention. The dialog control part 303 is composed of a scheduling part 401 and an agent managing part 402. The scheduling part 401 receives input information notified from the input part 301 such as an input device (e.g., a microphone, a keyboard, etc.), or dialog middleware, and manages the procedure up to the generation of output information corresponding to the input information. The agent managing part 402 requests a response regarding whether or not the input information can be processed with respect to each dialog agent 304 in accordance with a request from the scheduling part 401, selects the dialog agent 304 determined to be capable of processing the input information, and notifies the output part 302 of the response information output from the selected dialog agent 304.

It is assumed that the output part 302 accumulates response information notified from the agent managing part 402, and generates output information based on the output request from the scheduling part 401.

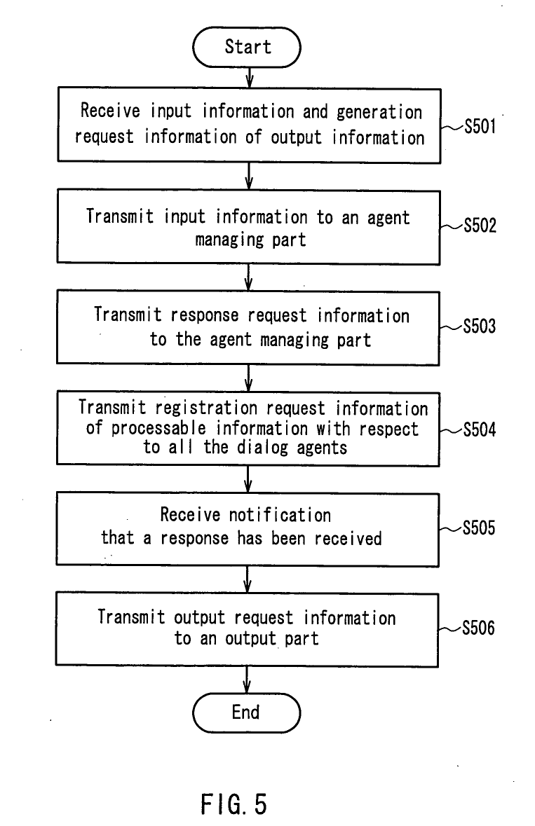

The processing flow in the scheduling part 401 is as follows. FIG. 5 is a flow chart illustrating the processing of the scheduling part 401 in the dialog control system according to the embodiment of the present invention.

In FIG. 5, first, the scheduling part 401 receives input information including generation request information of output information sent every time a user inputs in the input part 301 (Operation 501).

When receiving the generation request information of output information, the scheduling part 401 sends the input information to the agent managing part 402 (Operation 502). Then, the scheduling part 401 sends response request information based on the provided input information to the agent managing part 402 (Operation 503), and also sends registration request information to the agent managing part 402 so as to request it to register processable information of all the responded dialog agents 304 (Operation 504).

Finally, the scheduling part 401 receives a response from the dialog agent 304, from the agent managing part 402. When receiving notification that a response has been sent to the output part 302 (Operation 505), the scheduling part 401 sends output request information regarding the response to the output part 302 (Operation 506).

Herein, the processable information refers to information required for the dialog agent to generate a response using input information. For example, in the case where input information is user utterance information, a speech recognition grammar corresponds to the processable information.

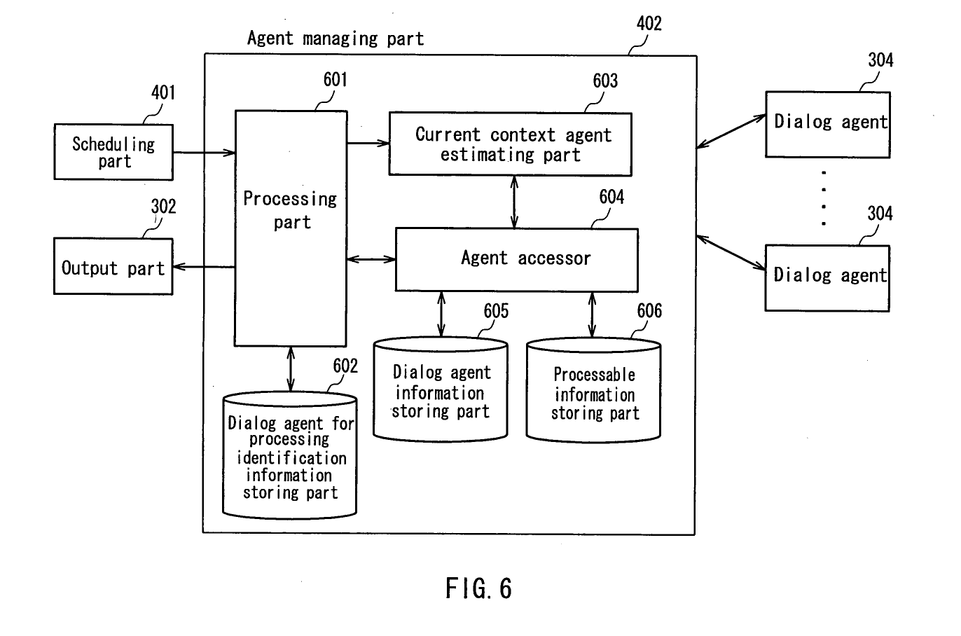

Next, FIG. 6 is a diagram showing a configuration of the agent managing part 402 in the dialog control system according to the embodiment of the present invention. In FIG. 6, first, the agent managing part 402 receives input information together with response request information from the scheduling part 401 in a processing part 601.

Then, the agent managing part 402 selects the dialog agent 304 that requests processing based on the input information received by the processing part 601 via an agent accessor 604. More specifically, the agent managing part 402 refers to a dialog agent information storing part 605 for storing identification information, a use number of times, and a final use date and time of the dialog agent 304 used by the user, information regarding a selection priority of the dialog agent 304, and the like, and a processable information storing part 606 for storing a recognition grammar and the like for use in the dialog agent 304, and selects the dialog agent 304 that can perform a dialog. At this time, the agent managing part 402 registers the recognition grammar and the like stored in the processable information storing part 606 with respect to all the dialog agents 304, and determines whether or not the dialog agent can perform processing in accordance with the contents of the response received from the dialog agent.

Furthermore, a current context agent estimating part 603 stores information regarding the dialog agent 304 that provides services and functions considered to be used by the user through a dialog. Thus, the current context agent estimating part 603 stores information such as an identification number, a current menu transition, and the like, as information regarding the dialog agent 304 that has finally performed a dialog with the user.

Furthermore, the processing part 601 has a dialog agent for processing identification information storing part 602 for temporarily storing identification information of the dialog agent that has processed a user input. Thus, a dialog agent that is processing user input information at a current time can be specified easily, and by performing processing such as enhancement of a selection priority of the dialog agent, a dialog can be performed smoothly.

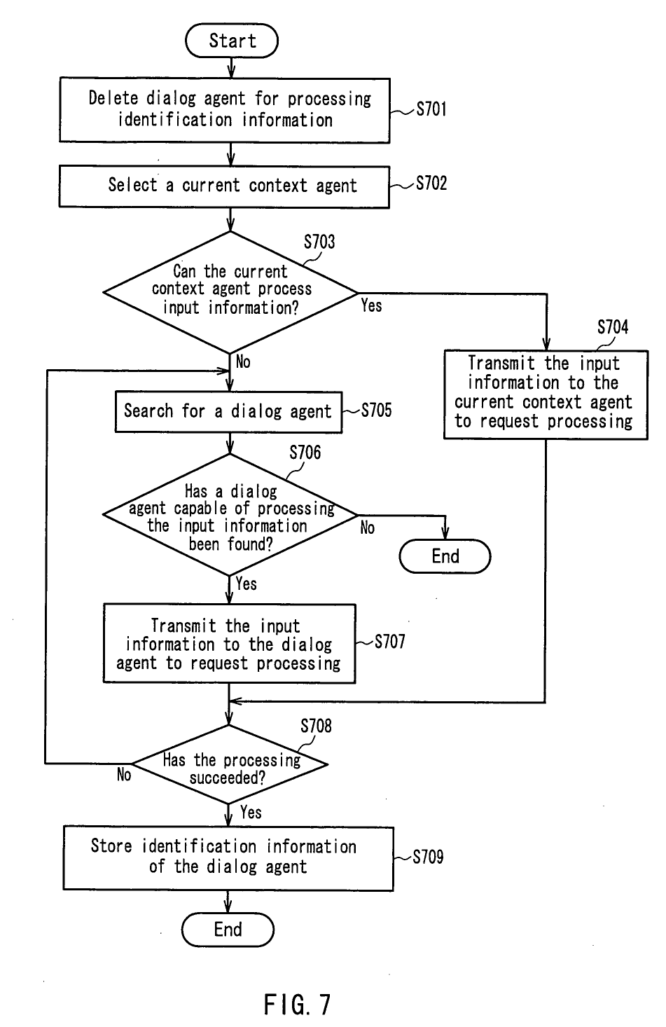

Next, the processing flow in the agent managing part 402 will be described. FIG. 7 is a flow chart illustrating input information processing in the agent managing part 402 in the dialog control system according to the embodiment of the present invention.

In FIG. 7, first, all pieces of the information stored in the dialog agent for processing identification information storing part 602 in the processing part 601 are deleted (Operation 701). Thereafter, a dialog agent (hereinafter, referred to as a “current context agent”) with which a user is performing a dialog is selected from the current context agent estimating part 603 (Operation 702).

When receiving identification information of the dialog agent that is performing a dialog from the current context agent estimating part 603, the agent managing part 402 inquires of the agent accessor 604 whether or not the selected dialog agent (i.e., the current context agent) can process the provided input information, using the identification information of the dialog agent as key information (Operation 703).

In the case where the current context agent can process the provided input information (Operation 703: Yes), the input information is sent to the dialog agent (current context agent) selected through the agent accessor 604 to request processing (Operation 704).

In the case where the current context agent cannot process the provided input information (Operation 703: No), the agent managing part 402 searches for dialog agents in the order of priority via the agent accessor 604 while referring to the dialog agent information storing part 605 so as to select a dialog agent other than the current context agent (Operation 705).

In the case where a dialog agent that can process the provided input information has not been found (Operation 703: No), the processing is completed. In the case where a dialog agent that can process the provided input information has been found (Operation 706: Yes), the input information is sent to the dialog agent to request the processing (Operation 707).

In the case where the failure (input information cannot be evaluated correctly in the dialog agent, etc.) of the processing is notified from the dialog agent (Operation 708: No), the agent managing part 402 again searches for a dialog agent with the second highest priority via the agent accessor 604 (Operation 705).

In the case where the processing has been succeeded (Operation 708: Yes), the identification information of the dialog agent that has performed the processing is stored in the dialog agent for processing identification information storing part 602, and the processing is completed (Operation 709).

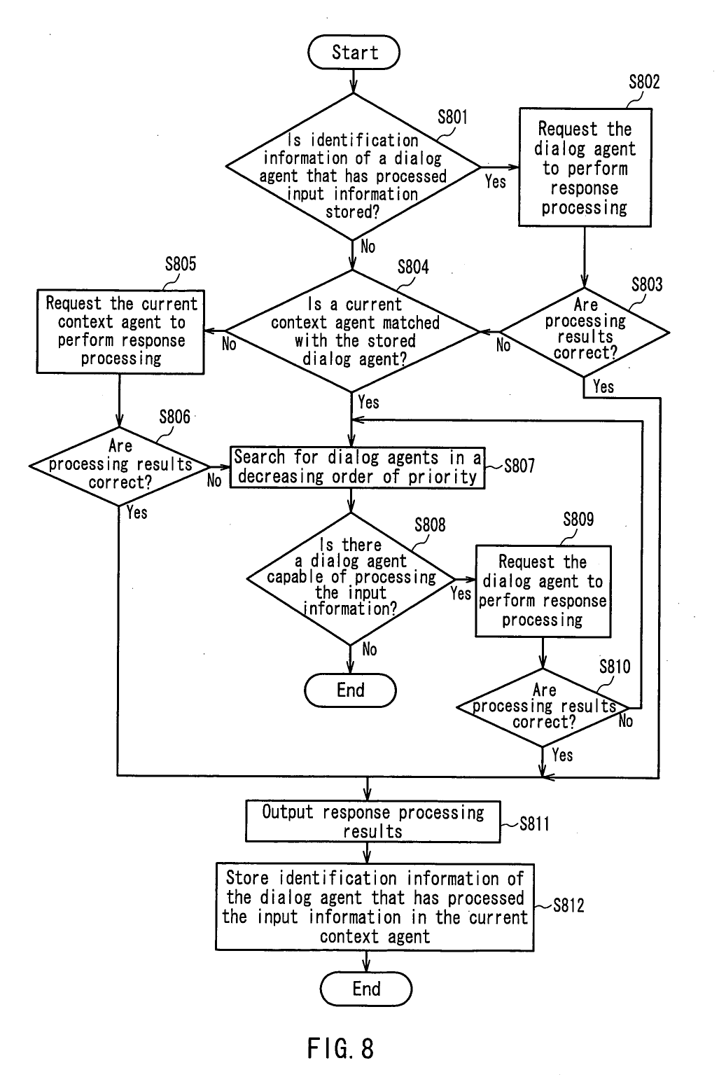

Next, FIG. 8 is a flow chart illustrating response request processing in the agent managing part 402 in the dialog control system according to the embodiment of the present invention.

In FIG. 8, the agent managing part 402 first confirms whether or not the identification information of the dialog agent that has processed input information is stored in the dialog agent for processing identification information storing part 602 in the processing part 601 (Operation 801). In the case where the identification information of the dialog agent that has processed input information is stored (Operation 801: Yes), the agent managing part 402 requests the response processing with respect to the dialog agent corresponding to the identification information through the agent accessor 604 (Operation 802).

Next, the agent managing part 402 determines whether or not the processing results to be notified from the dialog agent that has been requested to perform the response processing is correct (Operation 803).

In the case where the identification information of the dialog agent that has processed input information is not stored (Operation 801: No), or in the case where it is determined that the processing results of the response are not correct (Operation 803: No), the agent managing part 402 inquires of the current context agent estimating part 603 whether or not the identification information of the dialog agent stored in the dialog agent for processing identification information storing part 602 is matched with the identification information of the dialog agent that has been requested to perform processing and has processed the input information (Operation 804).

In the case where the identification information of the dialog agent stored in the dialog agent for processing identification information storing part 602 is different from the identification information of the dialog agent stored in the current context agent estimating part 603 (Operation 804: No), it is determined that the dialog agent stored in the current context agent estimating part 603 has not performed input processing with respect to the input information, and the agent managing part 402 requests the response processing through the agent accessor 604, using the identification information of the dialog agent (Operation 805).

In the case where the identification information of the dialog agent stored in the dialog agent for processing identification information storing part 602 is matched with the identification information of the dialog agent stored in the current context agent estimating part 603 (Operation 804: Yes), and it is determined that the results of the response processing is not correct (Operation 806: No), a dialog agent that can perform response processing is searched for in the order of priority while referring to the dialog agent information storing part 605 in the agent accessor 604 (Operation 807). At this time, by excluding a dialog agent, which has already been requested to process utterance, from a search target, the duplication of processing can be avoided.

When the dialog agent that can process input information is selected in the agent accessor 604 (Operation 808: Yes), the agent managing part 402 requests the selected dialog agent to perform response processing (Operation 809).

Next, in the case where the results of the response processing in the dialog agent are evaluated (Operation 810), and it is determined that the response processing has failed (Operation 810: No), a dialog agent with the second highest priority is searched for in the agent accessor 604 (Operation 807).

In the case where all the dialog agents have been searched for, and a dialog agent to be selected has not been found, the response processing in the processing part 601 is completed. On the other hand, in the case where it is determined that the response processing with respect to the dialog agent has succeeded (Operation 803: Yes, Operation 806: Yes, Operation 810: Yes), the results of the response processing in the dialog agent are output to the output part 302 (Operation 811).

Thereafter, the identification information of the dialog agent that has performed response processing is stored in the current context agent estimating part 603 (Operation 812). Thus, which dialog agent is performing a dialog with a current user can be determined with reference to the current context agent estimating part 603. Usually, it is determined that a newly registered dialog agent is determined to be a dialog agent of a current context.

It is also considered that the agent accessor 604 updates information on the priority of the dialog agents stored in the dialog agent information storing part 605 after performing the above-mentioned response processing. More specifically, it is considered that the priority of the responded dialog agents is increased. This means that the priority of the dialog agents with a high use frequency is set to be high. This can further simplify a user input.

For example, the following is assumed: there are a dialog agent that performs a service of “weather forecast” and a dialog agent that performs a service of “path search”, and both of them can process information of place names such as “Kobe” and “Kawasaki” as input information. In this case, assuming that a user often uses “Weather forecast”, the priority of the dialog agent that performs a service of “Weather forecast” is set to be high. Therefore, when a user merely inputs “Kobe”, the dialog agent that performs a service of “Weather forecast” can respond.

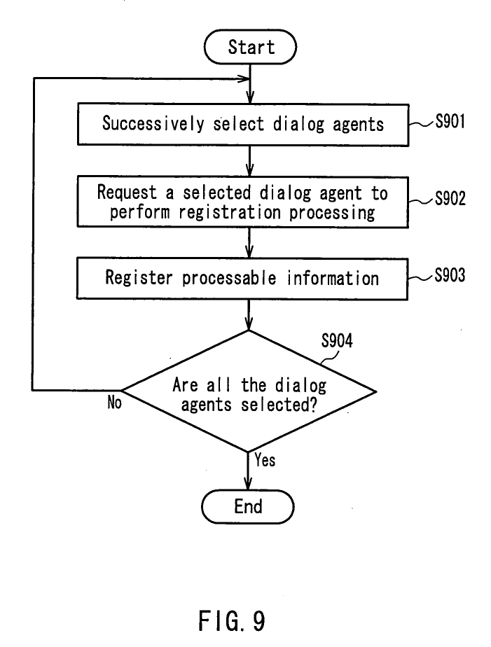

Next, the registration processing of processable information in the agent managing part 402 will be described. FIG. 9 is a flow chart illustrating registration processing of processable information in the agent managing part 402 in the dialog control system according to the embodiment of the present invention.

In FIG. 9, the processing part 601 requests the agent accessor 604 to successively select dialog agents (Operation 901). When the agent accessor 604 selects a dialog agent, the processing part 601 requests the agent accessor 604 to perform registration processing of the processable information (Operation 902).

Upon being requested to perform registration processing, each dialog agent registers processable information or the kind of information via the agent accessor 604 when performing the subsequent input information processing (Operation 903). The processable information to be registered is stored in the processable information storing part 606 for storing processable information by the agent accessor 604. The registration processing of the processable information is executed with respect to all the dialog agents (Operation 904).

Furthermore, the following is also considered. When the agent accessor 604 successively selects dialog agents in the registration processing of the processable information, dialog agents to be selected are limited in accordance with the amount and kind of stored information with reference to the processable input information storing part 606.

Thus, for example, in the case where speech recognition is performed, recognition vocabulary to be recognized can be limited. As a result, the problem, in which a recognition ratio is decreased as the recognition vocabulary to be recognized is increased, can be exactly solved. Furthermore, even in the case where a screen display and the like are performed, when there is a great amount of information to be input, in the case of use in a terminal and the like with a physically limited screen display area, a display is complicated, resulting in difficulty in an operation. However, by reducing the information to be input in accordance with the priority of the dialog agents, a screen display easy to see by a user can be performed.

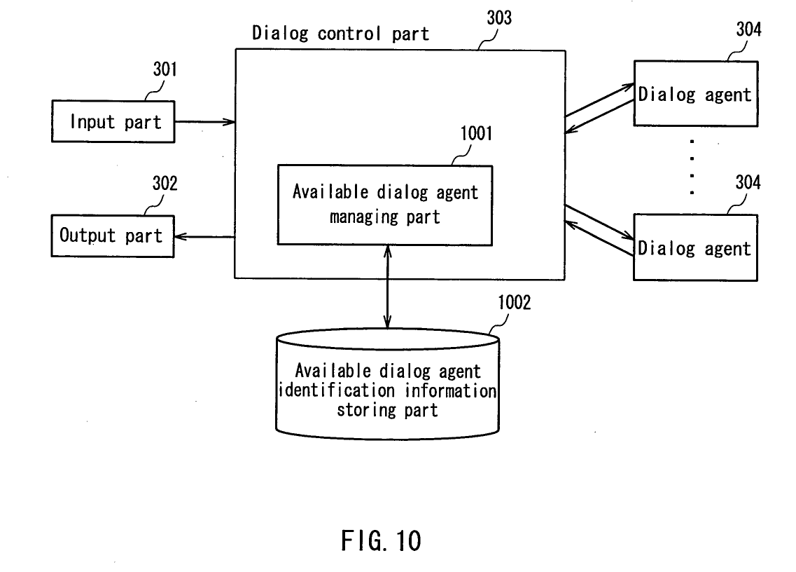

FIG. 10 is a diagram showing a configuration of a dialog control system having a function of changing the dialog agent 304 to be used. In FIG. 10, the dialog control part 303 allows the identification information regarding available dialog agents stored in the available dialog agent identification information storing part 1002 to be accessed from the agent accessor 604 of the agent managing part 402, through an available dialog agent managing part 1001. Thus, instead of searching for all the dialog agents 304, only available dialog agents stored in the available dialog agent identification information storing part 1002 can be searched for. By updating the contents of the available dialog agents stored in the available dialog agent identification information storing part 1002, the dialog agents to be searched for can be changed easily. Thus, in accordance with the situation, purpose, and the like of the user, dialog agents to be searched for can be changed.

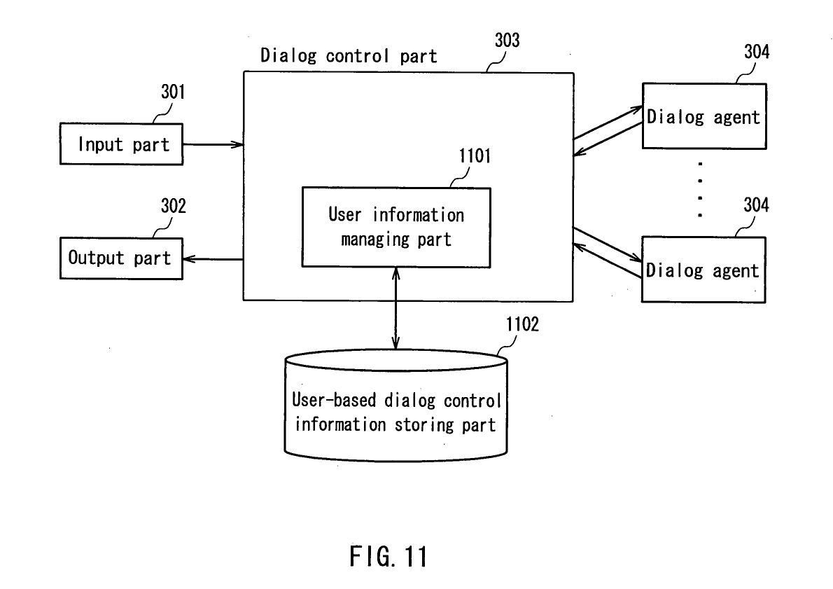

Next, FIG. 11 is a diagram showing a configuration of a dialog control system in the case where control information is stored outside on a user basis. In FIG. 11, information on a user including identification information of the user is input at the beginning of a dialog from the input part 301. Needless to say, a user information input part (not shown) for inputting information on a user may be separately provided. Alternatively, a speaker may be recognized based on the input speech data. Then, dialog control information on a user that is using the dialog control system is obtained from a user-based dialog control information storing part 1102 through the user information management part 1101.

Herein, “dialog control information” refers to dialog agent information in FIG. 6, available dialog agent identification information in FIG. 10, and the like. With such a configuration, the information on the selection priority of dialog agents can be used continuously, and even in the case where a user uses a dialog control system at a different timing, a dialog can be performed in the same manner as the previous one, using the same dialog agent.

As described above, according to the present embodiment, a user can exactly select a dialog agent that can handle input information. In addition, every time input information is input, dialog agents can be changed. Therefore, a dialog control system capable of performing a smooth dialog can be realized in a state close to a natural dialog in which category of input information is changed frequently.

In the dialog control system according to the present embodiment, a dialog is not limited to that using a speech. For example, any form such as a dialog using text data as in a chat room, etc., can be used as long as a dialog can be performed between a user and a system.

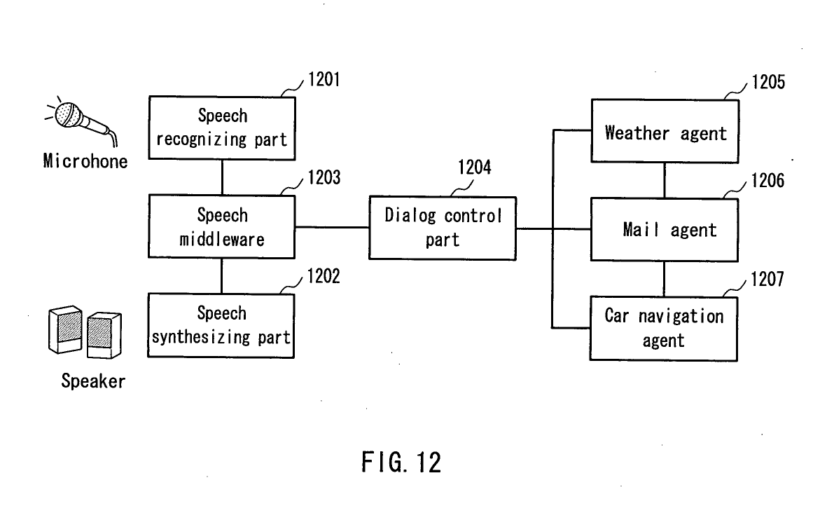

Hereinafter, the dialog control system according to an example of the present invention will be described. As shown in FIG. 12, in the present example, an application of the speech dialog system will be described, in which weather forecast is obtained using a speech, electronic mail is transmitted/received, and a schedule is confirmed.

In FIG. 12, the input part has a speech recognizing part 1201 for recognizing the words uttered by a human being through a general microphone, and converting the words into symbol information that can be dealt with by a computer. There is no particular limit to a recognition engine in the speech recognizing part 1201, and any generally used recognition engine may be used.

The output part has a speech synthesizing part 1202 for converting from text to speech data for output to a loudspeaker. There is no particular limit to the form of the speech synthesizing part 1202, and any generally used speech synthesizing part may be used in the same way as in the speech recognizing part 1201.

The input part has speech middleware 1203 for collectively controlling information of the speech recognizing part 1201 and the speech synthesizing part 1202. Even in the speech middleware 1203, a general technique such as VoiceXML or the like can be used.

The speech middleware 1203 notifies the dialog control part 1204 of input information recognized by the speech recognizing part 1201, and outputs output information from the dialog control part 1204 to the speech synthesizing part 1202. It is assumed that the dialog control part 1204 controls a plurality of dialog agents such as a weather agent 1205, a mail agent 1206, and a car navigation agent 1207.

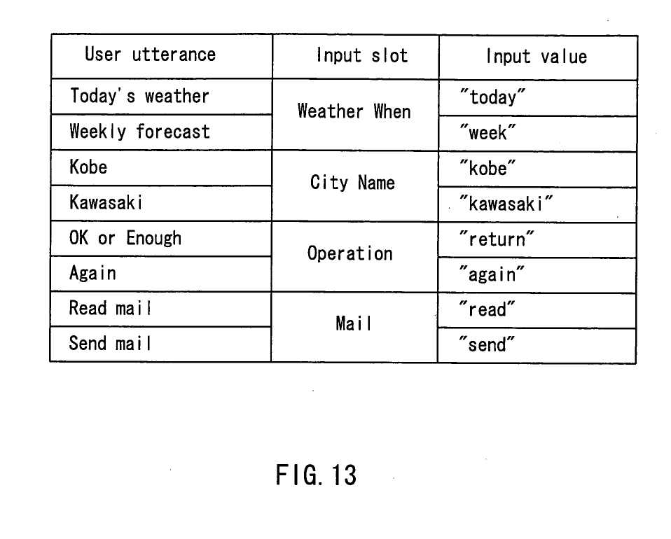

The input information transmitted from the speech middleware 1203 to the dialog control part 1204 is composed of an input slot representing the kind of input information and an input value representing an actual value of information. FIG. 13 illustrates input information used in the present example.

In FIG. 13, the contents actually uttered by a user correspond to a user utterance. A combination of an input slot and an input value corresponding to the user utterance is represented in a table form. For example, place names such as “Kobe” and “Kawasaki” are classified in the same input slot name “City Name”, which are given different input values “kobe” and “kawasaki”.

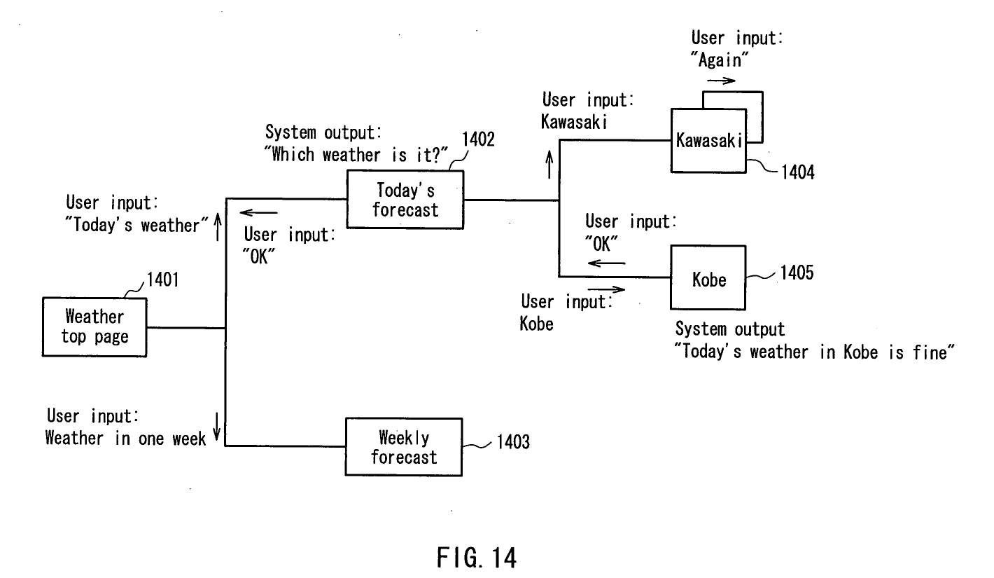

A dialog agent changes in a state in accordance with a user input and performs utterance processing in accordance with the change. FIG. 14 illustrates an operation of a “weather agent” that makes a weather forecast.

For example, in the case of a “weather agent” as shown in FIG. 14, an operation is first started from a weather top page 1401. When a user utters “Today's weather” in this state, the state is shifted to today's forecast 1402, and the system outputs “Which city's weather is it” as utterance processing. Then, when the user answers “Kobe”, the state is shifted to Kobe 1405, the system outputs “Today's weather in Kobe is fine”. Thereafter, when the user inputs “Return”, the state is shifted to the today's forecast 1402 again.

The dialog control part 1204 transmits user input information to a dialog agent. At this time, the dialog control part 1204 transmits the input information to the dialog agent based on input-possible information notified from the dialog agent. For example, when the weather agent 1205 is in a state of “Which city's weather is it?”, the weather agent 1205 can receive inputs such as “Kawasaki”, “Kobe”, and “Return” from a user. This means that an input value corresponding to an input slot “City Name” can be processed in the input information example shown in FIG. 13.

Thus, in this case, the weather agent 1205 notifies “City Name” as processable information with respect to the processable information registration processing from the dialog control part 1204. In the case where a user input is “Kobe”, the dialog control part 1204 determines that a weather agent can process the input, and requests the weather agent 1205 to process the input information. When the weather agent 1205 is shifted in a state, the dialog control part 1204 is notified of the success, and is requested to perform next utterance processing.

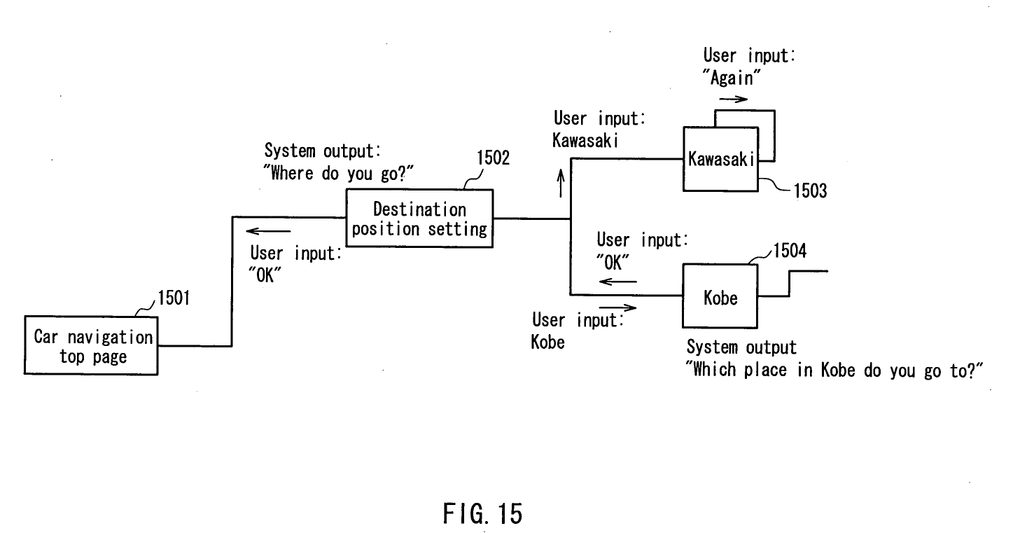

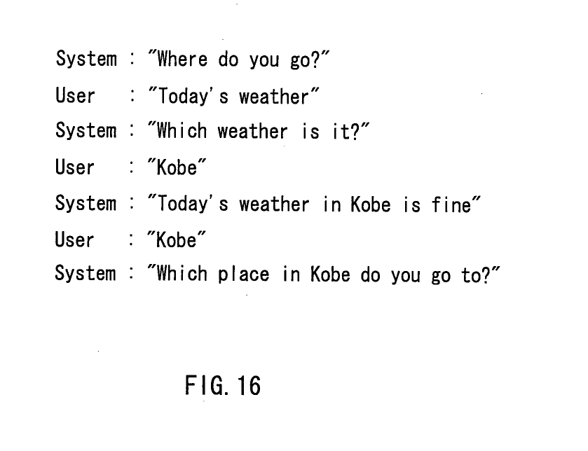

Next, FIG. 15 shows a part of an operation in the car navigation agent 1207. In FIG. 15, in the case where a user is setting a destination, the state is present at destination position setting 1502, and the state is shifted with the input information of a place name such as “Kawasaki” and “Kobe”, or an operation such as “Return”. When the user utters “Kobe”, the system utters “Which place in Kobe would you like to go to?”. In the case where the above-mentioned weather service 1205 and the car navigation agent 1207 are being simultaneously used, the car navigation agent 1207 notifies the dialog control part of input information of an input slot such as “City Name” and an input slot such as “Operation” as processable information. On the other hand, the weather agent 1205 notifies the dialog control part 1204 of input information of an input slot “Weather When” such as “Today's weather” and “Weekly forecast” as processable information i.e., a speech recognition grammar), since the state is present initially at the weather top page 1401.

In the case where a user asks the weather agent 1205 about today's weather, thinking about “I want to go to a place where it is fine” in the course of setting a destination position, when the user utters “Today's weather”, the speech recognizing part 1201 notifies the dialog control part 1204 of a pair of input information in which “Weather When” input slot is “today” through the speech middleware 1203 to request output processing.

When the scheduling part 401 of the dialog control part 1204 requests the agent managing part 402 to process input information, the processing part 601 of the agent managing part 402 searches the weather agent 1205 that registers a “Weather When” input slot from information registered in the processable information storing part 606 through the agent accessor 604, and registers identification information of the weather agent 1205 in the dialog agent information storing part 605.

Next, when the scheduling part 401 requests utterance processing, the agent managing part 402 determines that the dialog agent information of the weather agent 1205 is stored in the dialog agent information storing part 605, and requests the weather agent 1205 to perform utterance processing.

The weather agent 1205 shifts the state from the input information “Today's weather” to “Today's forecast”, and utters “Which city's weather is it?”. Furthermore, the processing part 601 notifies the current context agent estimating part 603 that the weather agent 1205 has uttered, and the current context agent estimating part 603 changes the dialog agent registered in the current context to the weather agent 1205.

Thereafter, the weather agent 1205 and the car navigation agent 1207 are requested to register the processable information from the scheduling part 401. Since the weather agent 1205 is shifted in a state, the processable information is newly registered. Herein, in the state of “Today's forecast” 1402, the input information corresponding to “City Name” such as “Kobe” and “Kawasaki” and input information corresponding to “Operation” such as “Return” can be processed.

Regarding the car navigation agent 1207, the state has not been shifted from the previous destination position setting. Therefore, the input information corresponding to “City Name” and “Operation”, which is the same as the previous one, can be processed. That is, in this stage, the dialog control part 1204 is notified that the weather agent 1205 and the car navigation agent 1207 can process input information of the same input slot.

In the case where the user inputs “Kobe” with respect to “Which city's weather is it?”, the agent managing part 402 having received the processing request of the input information from the scheduling part 401 requests the weather agent 1205 to process the input information via the agent accessor 604 for the following reason: when the processing part 601 selects a current context agent as a dialog agent from the current context agent estimating part 603, the weather agent 1205 is selected. Because of this, a dialog agent to be stored in the dialog agent for processing identification information storing part 602 of the processing part 601 becomes a weather agent 1205, and the weather agent 1205 is requested to perform utterance processing.

Thus, even in the case where the same input information can be processed by a plurality of dialog agents, a user can perform a dialog with the weather agent 1205 continuously based on the previous dialog results. Furthermore, when the user utters “Kobe” again, since only the car navigation agent 1207 can process the input information of “Kobe”, the car navigation agent 1207 is requested to process the input information.

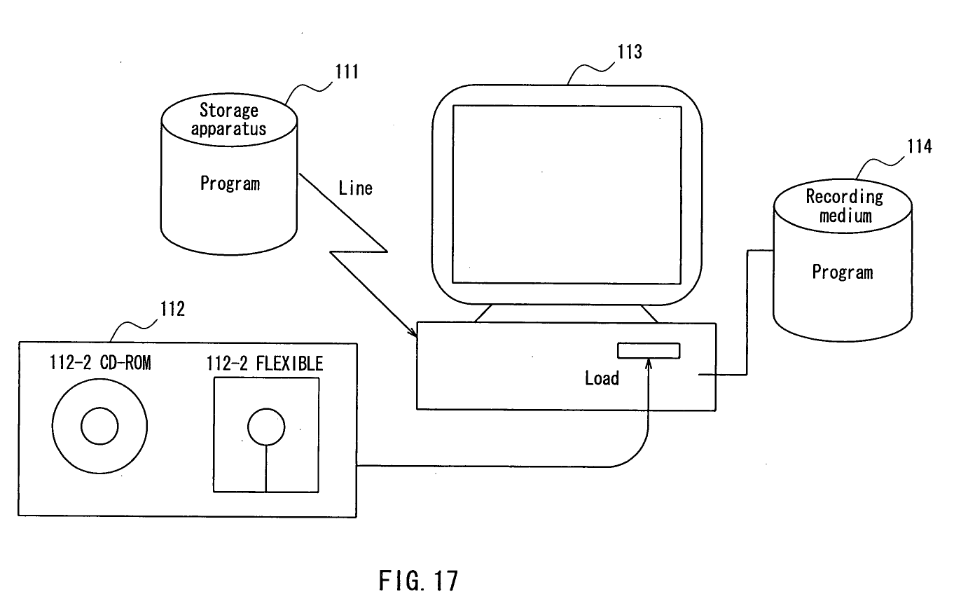

A program for realizing the dialog control system according to the embodiment of the present invention may be stored not only in a portable recording medium 172 such as a CD-ROM 172-1 and a flexible disk 172-2, but also in another storage apparatus 171 provided at the end of a communication line and a recording medium 174 such as a hard disk and a RAM of a computer 173, as shown in FIG. 17. In execution of the program, the program is loaded, and executed on a main memory.

Furthermore, data such as processable information generated by the dialog control system according to the embodiment of the present invention may also be stored not only in a portable recording medium 172 such as a CD-ROM 172-1 and a flexible disk 172-2, but also in another storage apparatus 171 provided at the end of a communication line and a recording medium 174 such as a hard disk and a RAM of a computer 173, as shown in FIG. 17. The data is read by the computer 173, for example, when the dialog control system of the present invention is used.

As described above, in the dialog control system according to the present invention, a dialog agent that can process input information can be exactly selected, and dialog agents can be changed every time input information is input. Therefore, a dialog control system can be realized, which is capable of performing a smooth dialog in a state close to a natural dialog in which the category of the input information is changed frequently.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A dialog control system, comprising:
an input part for interpreting input information input by a user;
a dialog agent for responding to the input information; and
a dialog control part placed between the dialog agent and the input part, for identifying a plurality of the dialog agents, transmitting the input information to the dialog agent to request a response to the input information, and transmitting a response from the dialog agent to an output part,
wherein, when the input information is input, the dialog control part inquires about processable information with respect to the plurality of dialog agents, stores the processable information, matches the input information with the processable information, selects the dialog agent capable of processing the input information, and transmits the input information to the selected dialog agent to receive a response thereto.

2. The dialog control system according to claim 1, wherein the dialog control part previously stores identification information of the dialog agents and selection priority of the dialog agents so that the identification information is associated with the selection priority, refers to the dialog agents in a decreasing order of the selection priority when referring to the input information and the processable information, and transmits the input information to the first selected dialog agent to request a response to the input information.

3. The dialog control system according to claim 2, wherein the dialog control part accumulates identification information of the dialog agent selected as a transmission destination of the input information, refers to the first stored dialog agent when selecting the subsequent dialog agent, in a case where the stored dialog agent is capable of processing the input information, transmits the input information to the stored dialog agent to request a response to the input information, and in a case where the stored dialog agent is not capable of processing the input information, refers to the dialog agents in a decreasing order of the selection priority.

4. The dialog control system according to claim 2, wherein the selection priority of the dialog agent is automatically updated in accordance with a use frequency.

5. The dialog control system according to claim 3, wherein the selection priority of the dialog agent is automatically updated in accordance with a use frequency.

6. The dialog control system according to claim 2, wherein, in the dialog control part, the control agents to be referred to are narrowed in accordance with contents of the input information, and the narrowed dialog agents are referred to in a decreasing order of the selection priority.

7. The dialog control system according to claim 3, wherein, in the dialog control part, the control agents to be referred to are narrowed in accordance with contents of the input information, and the narrowed dialog agents are referred to in a decreasing order of the selection priority.

8. The dialog control system according to claim 4, wherein, in the dialog control part, the control agents to be referred to are narrowed in accordance with contents of the input information, and the narrowed dialog agents are referred to in a decreasing order of the selection priority.

9. The dialog control system according to claim 1, wherein the dialog control part stores the identification information of the dialog agent determined to be available based on the processable information on a basis of the dialog agents, and the dialog control part inquires about the processable information with respect to only the dialog agent determined to be available.

10. The dialog control system according to claim 2, wherein the dialog control part includes a user information input part for inputting information for identifying a user, stores input information for identifying the user and information on a state using the dialog agent including the selection priority on a user basis, and performs processing in accordance with the selection priority on a user basis.

11. The dialog control system according to claim 3, wherein the dialog control part includes a user information input part for inputting information for identifying a user, stores input information for identifying the user and information on a state using the dialog agent including the selection priority on a user basis, and performs processing in accordance with the selection priority on a user basis.

12. The dialog control system according to claim 4, wherein the dialog control part includes a user information input part for inputting information for identifying a user, stores input information for identifying the user and information on a state using the dialog agent including the selection priority on a user basis, and performs processing in accordance with the selection priority on a user basis.

13. The dialog control system according to claim 5, wherein the dialog control part includes a user information input part for inputting information for identifying a user, stores input information for identifying the user and information on a state using the dialog agent including the selection priority on a user basis, and performs processing in accordance with the selection priority on a user basis.

14. The dialog control system according to claim 6, wherein the dialog control part includes a user information input part for inputting information for identifying a user, stores input information for identifying the user and information on a state using the dialog agent including the selection priority on a user basis, and performs processing in accordance with the selection priority on a user basis.

15. A dialog control method, comprising:
inquiring about processable information with respect to a plurality of dialog agents making responses corresponding to input information, and storing obtained processable information;
interpreting input information input by a user;
matching the input information with the processable information, selecting the dialog agent capable of processing the input information, and transmitting the input information to the selected dialog agent to request a response to the input information; and
receiving the response from the dialog agent and outputting it.

16. A program product storing a program on a recording medium, the program allowing a computer to execute the operations of:
inquiring about processable information with respect to a plurality of dialog agents making responses corresponding to input information, and storing obtained processable information;
interpreting input information input by a user;
matching the input information with the processable information, selecting the dialog agent capable of processing the input information, and transmitting the input information to the selected dialog agent to request a response to the input information; and
receiving the response from the dialog agent and outputting it.
